(19) United States
(12) Patent Application Publication
(10) Pub. No.: US 2025/0132109 A1
(43) Pub. Date: Apr. 24, 2025

(54) APPARATUS INCLUDING SPEAKERS PORTED THROUGH KEYS OF A KEYBOARD

(71) Applicant: Intel Corporation, Santa Clara, CA (US)

(72) Inventors: Shruthi Sudhakar, Bangalore (IN); Sumod Cherukkate, Bangalore (IN); Praveen Kashyap Ananta Bhat, Bangalore (IN); Prakash Kurma Raju, Bangalore (IN); Prasanna Pichumani, Bangalore (IN); A Ezekiel Poulose, Ernakulam (IN)

(73) Assignee: Intel Corporation, Santa Clara, CA (US)

(21) Appl. No.: 18/978,809

(22) Filed: Dec. 12, 2024

(51) Int. Cl. H01H 13/7065; H04R 1/02

(52) U.S. Cl. CPC H01H 13/7065; H04R 1/025; H04R 1/028; H01H 2239/048

(57) ABSTRACT

Apparatus including speakers ported through keys of a keyboard are disclosed. An example electronic device includes a housing, and a keyboard carried by the housing. The keyboard includes a key having a keycap that covers an associated switch. The example electronic device further includes a speaker within the housing underneath the keyboard. The keycap includes an opening to define a port through which sound from the speaker is able to pass.

### BACKGROUND

Audio performance of speakers in portable computer devices (e.g., mobile phones, tablets, laptops, etc.) is an important aspect of user experience. As portable computer devices continue to get smaller, there is less space for audio speakers presenting challenges to maintain audio performance.

### BRIEF DESCRIPTION OF THE DRAWINGS

FIG. 1 is an example electronic device constructed in accordance with teachings disclosed herein.

FIG. 2 is a close-up top view of a portion of the keyboard of FIG. 1 with keycaps for two of the keys removed to reveal the first speaker positioned underneath.

FIG. 3 is a close-up perspective view of the same portion of the keyboard shown in FIG. 2, but with the keycaps in place.

FIG. 4 is a close-up perspective view of an example key constructed in accordance with teachings disclosed herein.

FIG. 5 is a close-up perspective view of the example key of FIG. 4 with the example keycap drawn transparently to show the underlying features.

FIG. 6 is a cross-sectional side view of the example key of FIGS. 4 and 5.

FIG. 7 illustrates the example keycap of FIGS. 4-6 with the surrounding structure removed.

FIG. 8 illustrates an alternate example of the keycap of FIGS. 4-6 with the surrounding structure removed.

FIG. 9 is a close-up perspective view of another example key constructed in accordance with teachings disclosed herein.

FIG. 10 is a cross-sectional view of an example keyboard with an example backlight assembly.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Industrial design of electronic devices relates to the visual design or appearance of devices while providing the functionality needed for a positive user experience. An important consideration in the industrial design of laptops (among other types of electronic devices) is the placement of speaker ports (e.g., speaker vents, speaker holes, speaker ducts). A clean appearance with reduced holes on C and D covers of a laptop (e.g., the front and back covers of the base portion containing the keyboard) has become an increasingly important design consideration for thin and light-weight devices. Another design consideration that is becoming increasingly important is the size of laptop keyboards. Specifically, there is growing demand for keyboards that extend towards and/or up to the outer (lateral) edges of a laptop base in 13-inch and narrow bezel 14-inch thin and light devices to improve typing experience. In the past, a common location for speakers in a laptop was on either side of a keyboard with porting vents in the C cover. However, this traditional approach does not satisfy either of the above-noted design considerations. On the other hand, direct porting of speakers (which is usually achieved through the C cover on laptops) is important to provide good speaker treble response (e.g., response at sound frequencies greater than 10 kHz) for quality user experience.

There are different known approaches to eliminate or reduce the appearance of holes in the C cover while still attempting to provide reasonable sound quality. One known approach involves positioning speakers in the base of a laptop close to the hinge that connects the base to the lid with holes for speaker porting facing away from a user and towards the hinge and/or the lid attached thereto. In this arrangement, the holes are less visible to the user. However, the location of the holes results in sounds from the speakers having to reflect off the open lid to reach the speaker, which can reduce the sound quality, especially at relatively high frequencies. Another challenge with this approach is that it requires speakers to be positioned at locations that are commonly needed for fans and/or associated vents to cool the electronic device.

Another known approach is to position speakers underneath the keyboard with the soundwaves passing through the narrow gaps between the keys of the keyboard. However, this approach presents challenges due to the way keys are shaped. Typically, a key on a keyboard includes a keycap that contains a cavity that faces downward to cover or partially enclose an associated switch assembly. Thus, soundwaves produced by a speaker positioned underneath a keyboard are directed towards and into the cavity of the keycap before being forced around the keycap and through the gap between adjacent keys. The cavity of the keycap produces standing waves and resonance that can impact the single pressure level (SPL) response and/or result in distortion of the sound, thereby lowering the sound quality.

Examples disclosed herein improve the sound quality relative to existing approaches with porting vents contained in the keycaps of keys on a keyboard below which a speaker is located. By porting the speakers directly through the keycaps, the problems of standing waves and resonance caused by the cavity on the underside of the keycap are avoided. More particularly, in some examples, the total harmonic resonance (THDN) is less than or equal to approximately 5% with a minimum frequency response of at least 12 kHz. Further, in some examples, the holes in the keycaps for the speaker porting are positioned on the sidewalls of the keycaps facing towards a user to provide for direct porting without the need for the soundwaves to reflect off the screen or other part of a laptop lid.

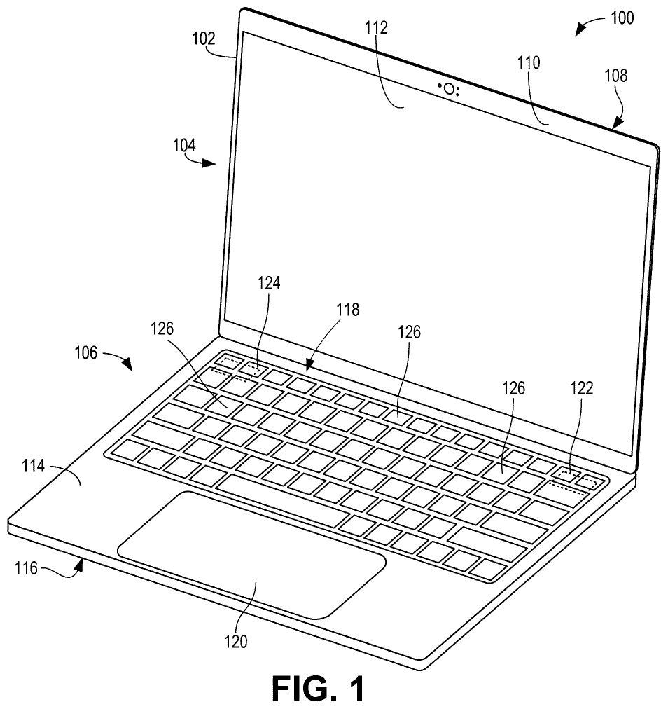

FIG. 1 illustrates an example electronic device 100 constructed in accordance with teachings disclosed herein. In the illustrated example, the electronic device 100 is a laptop computer that includes a chassis or housing 102 having a lid 104 and a base 106. In some examples, the lid 104 includes an A cover 108 and a B cover 110. A display screen 112 is disposed in the B cover 110 of the lid 104. In some examples, the display screen 112 is a touch sensitive display (e.g., a touchscreen). In some examples, the base 106 includes a C cover 114 and a D cover 116. In this example, a keyboard 118 and a touchpad 120 are disposed in the C cover 114. In some examples, the lid 104 is rotatably coupled to the base 106 via a hinge to enable the lid 104 to be moved (e.g., opened and closed) relative to the base 106.

In the illustrated example, the electronic device 100 includes one or more speakers (e.g., a first speaker 122 and a second speaker 124) positioned underneath (e.g., behind) one or more keys 126 of the keyboard 118. That is, the speakers 122, 124 are positioned between the keyboard 118 and the D cover 116 (e.g., the bottom cover) of the electronic device 100. That the speakers 122, 124 are buried underneath the keyboard 118 is the reason the speakers 122, 124 are represented by dashed lines in the illustrated example of FIG. 1. Although the example electronic device 100 is shown and described as a laptop, the electronic device 100 can be any sort of device that includes at least one key 126 and at least one speaker 122, 124 (e.g., a mobile phone, a handheld gaming device, a standalone keyboard with embedded speakers, etc.).

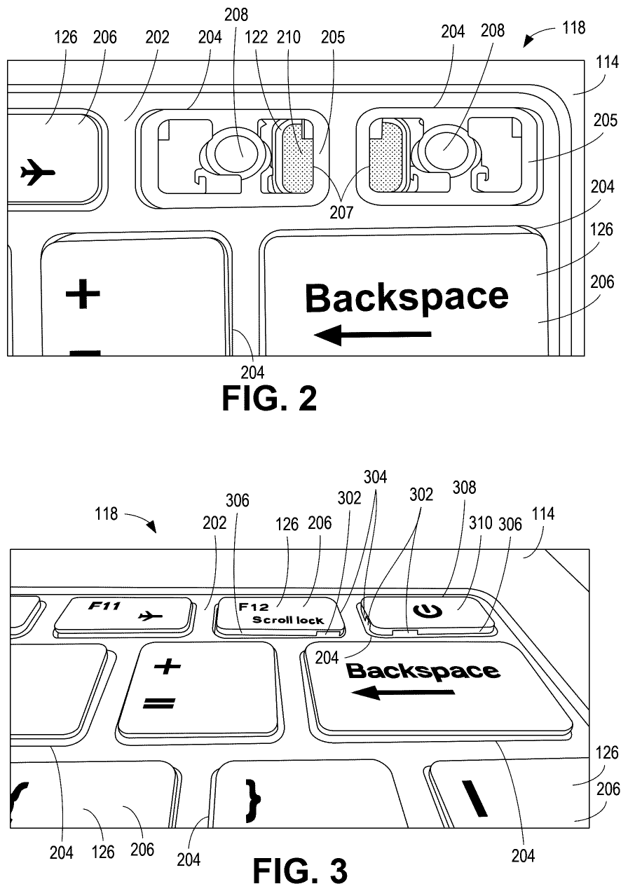

FIG. 2 is a close-up top view of a portion of the keyboard 118 of FIG. 1 with keycaps for two of the keys 126 removed to reveal the first speaker 122 positioned underneath. FIG. 3 is a close-up perspective view of the same portion of the keyboard 118 shown in FIG. 2, but with all keycaps in place. As shown in the illustrated example, the keyboard 118 includes a baseplate 202 with a plurality of holes 204 (e.g., openings, apertures, etc.). In some examples, the baseplate 202 includes recessed surfaces 205 within the holes 204 that line the perimeters of respective ones of the holes 204. In some examples, the recessed surfaces 205 include one or more apertures 207 (e.g., openings, holes, ducts, etc.) that extend all the way through the baseplate 202 to expose the area thereunder. In some examples, the recessed surfaces 205 are omitted. That is, in some examples, the apertures 207 correspond to (e.g., are aligned with) the holes 204.

In this example, each hole 204 is associated with a different key 126 of the keyboard 118. As such, in this example, each hole 204 contains and/or is associated with a corresponding keycap 206. In some examples, as shown, the keycaps 206 are slightly smaller than (e.g., fit within) the holes 204, but are larger than (e.g., cover) the apertures 207 within the recessed surfaces 205 in the holes 204. In other examples, the keycaps 206 may be larger than (e.g., to completely cover) the holes 204. In some example, multiple keycaps 206 can cover different portions of the same hole 204 in the baseplate 202. In some examples, the baseplate 202 includes a single hole 204 for all the keys 126. In some examples, the baseplate 202 is omitted entirely. Each keycap 206 covers (e.g., extends over top of) and is operatively coupled to an underlying switch assembly 208 (or switch for short) aligned with and protruding through the corresponding hole 204 (and the associated aperture 207) in the baseplate 202 of the keyboard 118. Thus, when a keycap 206 is pressed down by a user, the keycap 206 presses down the switch assembly 208 to trigger an electrical signal associated with the corresponding key 126.

As shown in the illustrated example of FIG. 2, the first speaker 122 is positioned underneath and in alignment with the apertures 207 in the recessed surfaces 205 of the holes 204 associated with the two keycaps 206 that have been removed. More particularly, as shown in the illustrated example, the first speaker 122 includes a diaphragm 210 that spans across the gap between the adjacent holes 204 and at least part way into the area associated with the apertures 207. In some examples, the first speaker 122 is smaller than what is shown in FIG. 2 and is positioned in alignment with (e.g., overlaps the area of) only one key 126 on the keyboard 118. In other examples, the first speaker 122 is larger than what is shown in FIG. 2 and is positioned in alignment with (e.g., overlaps the area of) three or more keys 126.

Based on the position of the first speaker 122, as shown in FIG. 2, soundwaves produced by the diaphragm 210 travel upwards and directly towards the underside of the keycaps 206 positioned overtop of the holes 204 where the first speaker 122 is located. The underside of the keycaps 206 includes a cavity in which the switch assembly 208 is received and housed. Such cavities on the underside of the keycaps 206 can lead to standing waves and/or resonance that weaken and/or distort the soundwaves produced by the diaphragm 210. To overcome these concerns, the example keycaps 206 positioned over the first speaker 122 include one or more openings 302 (e.g., holes, apertures, ports, vents, ducts, etc.) through which sound from the first speaker 122 is able to pass, as shown in FIG. 3. In this example, the openings 302 are in sidewalls of the keycaps 206. More particularly, in this example, the openings are included in both lateral sidewalls 304 of the keycaps 206 and user-facing sidewalls 306 of the keycaps 206. In some examples, the openings 302 are limited to the lateral sidewalls 304. In some examples, the openings 302 are limited to the user-facing sidewalls 306. Additionally or alternatively, in some examples, the openings 302 can be at other places on the keycaps 206. For instance, in some examples, the keycaps 206 include one or more openings 302 on a screen-facing sidewall 308. In some examples, the keycaps 206 include one or more openings on a front face 310 of the keycaps 206 (e.g., the surface directly pressed by a user).

In some examples, the openings 302 in the keycaps 206 are positioned adjacent to (e.g., aligned with) the area of the keycaps 206 that overlap the first speaker 122. Thus, as shown in FIG. 3, the keycap 206 on the left side of the speaker 122 includes openings 302 close to the right side of the keycap 206, whereas the keycap 206 on the right side of the speaker 122 includes openings 302 close to the left side of the keycap 206. Further, in some examples, the openings 302 are positioned towards a user. Thus, as shown in FIG. 3, the opening 302 in the lateral sidewall 304 of the rightmost keycap 206 is closer to the user-facing sidewall 306 than the opening 302 is to the screen-facing sidewall 308. In other examples, different positions for the openings 302 are possible.

When the keycaps 206 are pressed down, the openings 302 are pushed towards the baseplate 202 (e.g., towards the recessed surface 205). In some situations, this can reduce the size of the area through which soundwaves are able to vent, which may negatively impact the sound quality. Accordingly, in some examples, the first speaker 122 is positioned underneath keys 126 that a user is not expected to use (e.g., press) very often to reduce the impact of the user pressing such keys on sound quality perceived by the user. Thus, in this example, the first speaker 122 is aligned with a function key (e.g., the F12 key) and a power key (e.g., an on/off key). However, the first speaker 122 can be aligned with any other key(s) 126 of the keyboard in addition to or instead of the function keys and/or the power key.

Providing speakers underneath the keyboard 118 with direct porting, as disclosed herein, provides several advantages over known electronic devices. Specifically, many known high-end devices include four speakers including two woofers and two tweeters for high fidelity audio. Often, the two tweeters are positioned on either side of a keyboard with direct porting through the C cover with the larger woofers placed near the battery with side porting. With speakers under the keyboard 118, as in disclosed examples, a similar performance to such known high-end devices can be achieved with only two full range speakers. This is possible because the position of such speakers (underneath a keyboard) allows for larger speakers (for quality bass performance) and direct porting (for quality treble performance). Furthermore, examples disclosed herein eliminate the need for speakers on either side of the keyboard, thereby enabling a larger keyboard and a cleaner appearance. Further still, examples disclosed herein eliminate the need for the side porting of woofers, thereby providing more space to exhaust air from a fan used to cool the electronic device.

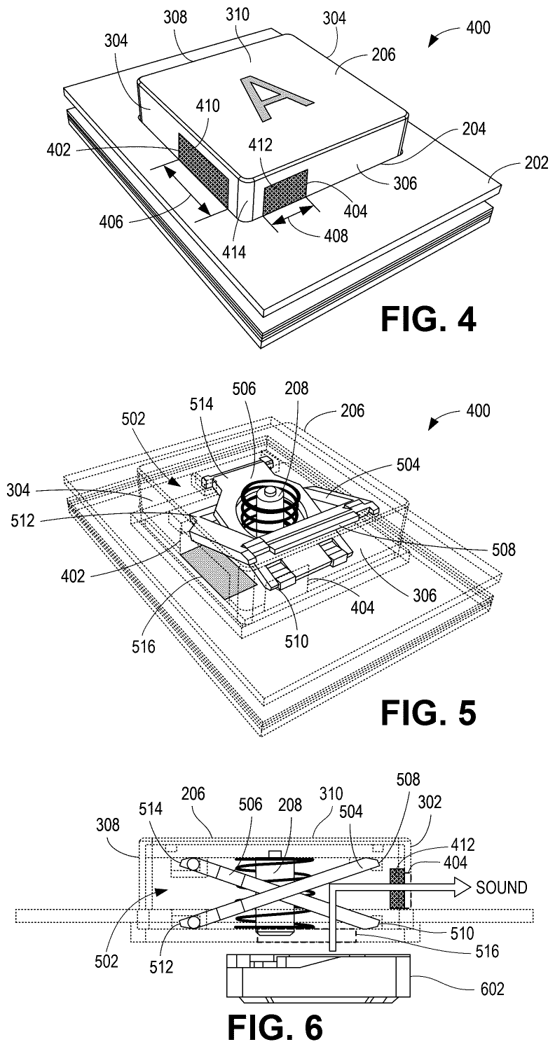

FIG. 4 is a close-up perspective view of an example key 400 constructed in accordance with teachings disclosed herein. FIG. 5 is a close-up perspective view of the example key 400 of FIG. 4 with the example keycap drawn transparently to show the underlying features. FIG. 6 is a cross-sectional side view of the example key 400 of FIGS. 4 and 5. The example key 400 of FIGS. 4-6 is the same or similar to the keys 126 of FIGS. 1-3. Thus, the same reference numbers used in FIGS. 1-3 are used for the same or similar features shown in FIGS. 4-6. Further, the description of such features provided above in connection with FIGS. 1-3 applies similarly to the corresponding features shown in FIGS. 4-6.

As shown in FIG. 4, the example key 400 includes a keycap 206 that is positioned within and protrudes out from a hole 204 in a baseplate 202 of an example keyboard (e.g., the keyboard 118 of FIGS. 1-3). The example keycap 206 includes two lateral sidewalls 304, a user-facing sidewall 306, a screen-facing sidewall 308, and a front face 310. As shown in FIGS. 5 and 6, the sidewalls 304, 306, 308 define the perimeter of a cavity 502 of the keycap 206 that surrounds (e.g., encloses, contains, houses, etc.) a switch assembly 208 (or switch for short). In some examples, the switch 208 is a scissor switch that includes two arms (e.g., a first arm 504 and a second arm 506) angled relative to one another in a scissor shape. More particularly, in this example, the arms are rotatably coupled along an axis extending between the two lateral sidewalls 304 near a midpoint of the arms 504, 506 with respective first ends 508, 510 proximate the user-facing sidewall 306 and respective second ends 512, 514 proximate to the screen-facing sidewall 308 (e.g., distal to the user-facing sidewall 306). In other examples, the axis for the scissor mechanism extends between the user-facing sidewall 306 and the screen-facing sidewall 308 with the ends 508, 510, 512, 514 adjacent the lateral sidewalls 304.

In the illustrated example, a first opening 402 (corresponding to a first one of the openings 302 shown in FIG. 3) is in the lateral sidewall 304 and a second opening 404 (corresponding to a second one of the openings 302 in FIG. 3) is in the user-facing sidewall 306. The example first opening 402 has a first width 406 and the example second opening 404 has a second width 408. In this example, the first width 406 is greater than the second width 408. More particularly, in some examples, the first width 406 is approximately 2.8 mm and the second width 408 is approximately 1.8 mm. However, the widths 406, 408 can be any other suitable dimension. In some examples, the first width 406 is less than or equal to the second width 408. In some examples, the width of either opening 402, 404 is greater than a height of the openings 402, 404. For instance, in some examples, the height of each opening is approximately 0.7 mm. However, the height can be any other suitable dimension. In some examples, the height is equal to or greater than one or both of the widths 406, 408. In some examples, either the first opening 402 or the second opening 404 is omitted. In some examples, the keycap 206 includes additional openings not shown.

In some examples, first and second meshes 410, 412 fill, cover, and/or extend across the respective first and second openings 402, 404. The meshes 410, 412 serve to prevent foreign substances (particulates, liquids, etc.) from passing through the openings 402, 404 and into the cavity 502. Further, the meshes 410, 412 can also reduce the visibility of the openings 402, 404 for a cleaner appearance. In some examples, as shown in FIG. 6, the meshes 410, 412 are attached to an inner surface of a cavity 502 (e.g., the inside surface of the corresponding sidewalls 304, 306) of the keycap 206. In other examples, the meshes 410, 412 are disposed within the openings 402, 404 to be aligned with (e.g., substantially flush with) the sidewalls 304, 306. In some examples, the first and second meshes 410, 412 are integrally connected as different parts of a single mesh. In some examples, the meshes 410, 412 are approximately 0.1 mm thick.

In some examples, the baseplate 202 includes a duct 516 (e.g., a hole, an opening, a vent, a port, etc.) to facilitate soundwaves from a speaker 602 (shown in FIG. 6) to enter the cavity 502 of the keycap 206. In some examples, the duct 516 corresponds to the apertures 207 shown in FIG. 2. In other examples, the duct 516 is a hole or cutout within the recessed surfaces 205 shown in FIG. 2. In some examples, the duct 516 can be any suitable size. In some examples, the duct 516 is approximately 4 mm long by 2 mm wide. However, the duct 516 can have any other suitable dimensions. As shown in the illustrated example of FIG. 6, the speaker 602, the duct 516, and the cavity 502 are arranged in a straight line. Further, in some examples, the duct 516 is positioned underneath and/or align with the first arm 504, which, in this example, is closer to the lateral sidewalls 304 than the second arm 506. Further, in this example, the first end 508 of the first arm 504 is closer to the front face 310 of the keycap 206 than the first end 510 of the second arm 506 is to the front face 310. Thus, the first arm 504 is angled or slanted upwards toward the user-facing sidewall 306 of the keycap 206. As a result of the arrangement shown in the illustrated example, soundwaves produced by the speaker 602 directly under the first arm 504 may reflect off the first arm 504 towards and out through the second opening 404 on the user-facing sidewall 306. That is, in some examples, the speaker 602, the duct 516, and the openings 402, 404 are positioned so that the arms 504, 506 of the switch assembly 208 help guide sound from the speaker 602 toward the openings 402, 404. More particularly, in some examples, to facilitate a direct travel path for the soundwaves (e.g., a fluid path for air), the second opening 404 is positioned in general alignment with the duct 516 and/or the first arm 504 (at least the portion of the first arm 504 adjacent the sidewall 304). In some examples, to further facilitate the travel path of the soundwaves, the first opening 402 is closer to the first end 508 of the first arm 504 (which is angled up higher) than the first opening 402 is to the second end 512 of the first arm 504 (which is angled down lower). In other words, in some examples, the first opening 402 is closer to the user-facing sidewall 306 than the first opening 402 is to the screen-facing sidewall 308. Thus, as shown in the illustrated example, both the first and second openings 402, 404 are adjacent a first edge 414 joining the lateral sidewall 304 and the user-facing sidewall 306 and distal to opposing edges of the lateral sidewall 304 and the user-facing sidewall 306.

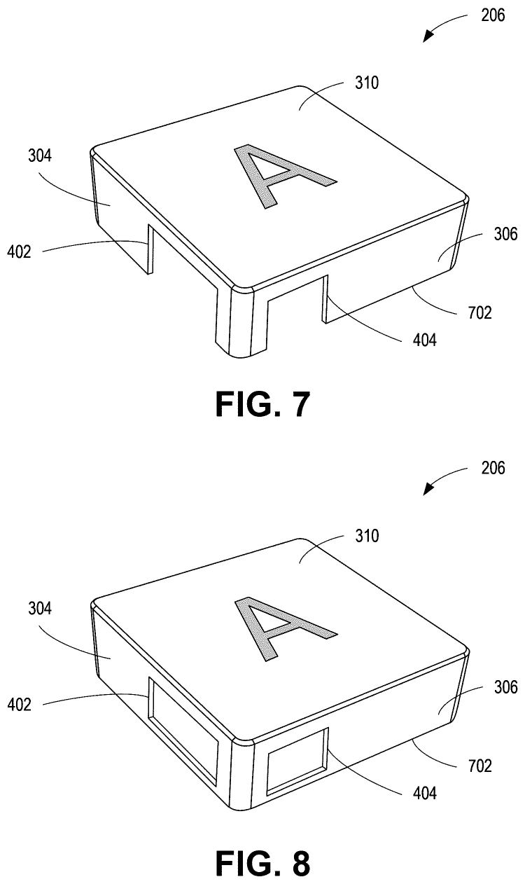

FIG. 7 illustrates the example keycap 206 of FIGS. 4-6 with the surrounding structure (including the meshes 410, 412) removed. As shown in the illustrated example, the openings 402, 404 are cutouts in the sidewalls 304, 306 that extend from a rear rim 702 of the keycap 206 toward the front face 310. FIG. 8 illustrates an alternate example of the keycap 206 of FIGS. 4-6 with the openings 402, 404 being holes spaced apart from the rear rim 702.

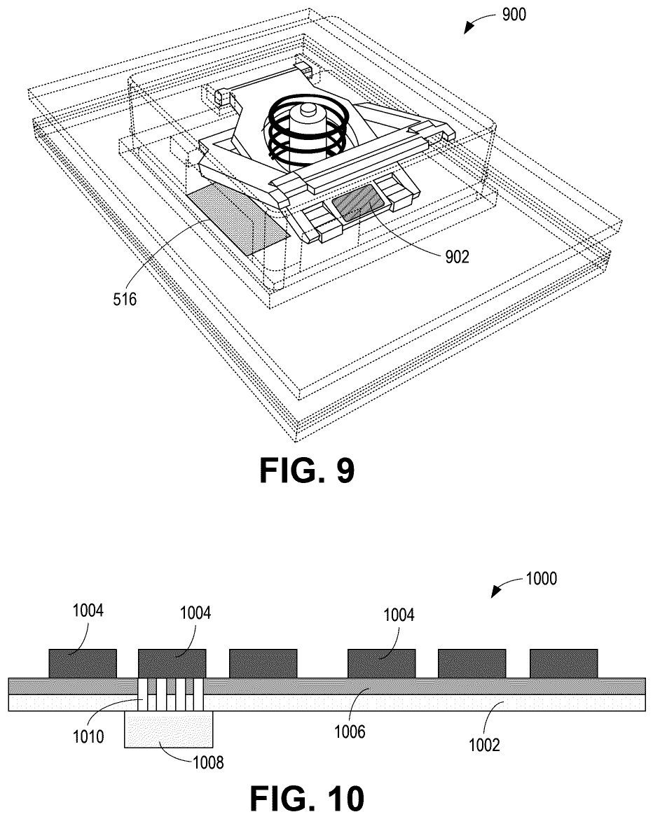

As detailed above, teachings disclosed herein can be implemented using existing designs keys on a keyboard. That is, examples disclosed herein do not require any significant redesign of keycaps (aside from the inclusion of the openings 402, 404) or of the switch assemblies 208. Furthermore, teachings disclosed herein can be used in combination with existing techniques to provide backlighting for keys of a keyboard. Specifically, one approach for backlit keys is to include one or more light emitting diodes (LEDs) underneath each keycap. FIG. 9 illustrates an example key 900 similar to the example key 400 of FIGS. 4-6 except that an LED 902 has been included. As shown, the LED 902 is spaced apart from the duct 516 and, therefore, should not have a significant impact on the travel path of soundwaves from the speaker to the external environment as described above.

Another approach for backlit keys is with a backlight assembly that globally illuminates a group of multiple (e.g., all) keys of a keyboard. FIG. 10 is a cross-sectional view of an example keyboard 1000 with such a backlight assembly 1002. As shown, the example keyboard 1000 includes a plurality of keys 1004 supported on a baseplate 1006 with a speaker 1008 that is positioned underneath at least one of the keys 1004. In this example, the backlight assembly 1002 is between the keys 1004 and the speaker 1008. Accordingly, in some examples, to port the speaker 1008 through the corresponding key 1004, one or more slots 1010 (e.g., through-holes, passageways, etc.) extend through the backlight assembly 1002 to fluidly couple the speaker 1008 with the cavity of the associated key 1004 via an air passage extending therebetween.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable improved sound quality with few speakers in electronic devices that have a cleaner industrial design with fewer and/or smaller visible holes for speaker porting. Fewer speakers is achieved by employing larger speakers where there is more space underneath a keyboard rather than multiple smaller woofers and tweeters are different locations. Further, by positioning the speakers underneath, this eliminates speaker porting through the C cover for a cleaner appearance. Instead, speaker porting is achieved through openings in keycaps of one or more keys of the keyboard. This provides for direct porting while avoiding concerns of standing waves and sound distortion that can arise by attempting to port the speakers around the keycaps, thereby achieving higher quality sound that other known approaches.

Further examples and combinations thereof include the following:
Example 1 includes an electronic device comprising a housing, a keyboard carried by the housing, the keyboard including a key having a keycap that covers an associated switch, and a speaker within the housing underneath the keyboard, the keycap including an opening to define a port through which sound from the speaker is able to pass.
Example 2 includes the electronic device of example 1, wherein the keycap includes a front face and a sidewall, the opening in the sidewall.
Example 3 includes the electronic device of example 2, wherein the sidewall is a user-facing sidewall.
Example 4 includes the electronic device of any one of examples 2 or 3, wherein the sidewall is a first sidewall that extends between second and third sidewalls of the keycap, the opening closer to the second sidewall than the opening is to the third sidewall.
Example 5 includes the electronic device of any one of examples 2-4, wherein the sidewall is a first sidewall and the opening is a first opening, the keycap including a second opening in a second sidewall.
Example 6 includes the electronic device of example 5, wherein the first opening has a first width and the second opening has a second width, the first width greater than the second width.
Example 7 includes the electronic device of example 6, wherein the switch is a scissor switch that includes a first arm angled relative to a second arm in a scissor shape, the first and second arms having respective first ends proximate the second sidewall and respective second ends distal to the second sidewall.
Example 8 includes the electronic device of example 7, wherein the first end of the first arm is closer to the front face than the first end of the second arm is to the front face, the first arm is closer to the first sidewall than the second arm is to the first sidewall, and the first opening is closer to the first end of the first arm than to the second end of the first arm.
Example 9 includes the electronic device of any one of examples 5-8, wherein the first and second sidewalls are joined at a first edge, both the first and second openings adjacent the first edge and distal to opposing edges of the first and second sidewalls.
Example 10 includes the electronic device of any one of examples 2-9, wherein the keyboard includes a baseplate, the baseplate between the speaker and the keycap, the baseplate including a duct therethrough, the duct aligned with the keycap to provide a fluid path for air from the speaker to the opening.
Example 11 includes the electronic device of any one of examples 2-10, wherein the opening is a cutout that extends from a rear rim of the keycap toward the front face.
Example 12 includes the electronic device of any one of examples 1-11, further including a mesh across the opening.
Example 13 includes the electronic device of any one of examples 1-12, further including a backlight assembly to illuminate the keyboard, the backlight assembly between the keyboard and the speaker, the backlight assembly including a through-hole to define an air passage between the speaker and the opening in the keycap.
Example 14 includes the electronic device of any one of examples 1-13, wherein the key is a first key, and the keycap is a first keycap, the speaker to span an area at least partially aligned with the first key and at least partially aligned with a second key of the keyboard, the second key adjacent to the first key, the second key including a second keycap, the second keycap including a second opening.
Example 15 includes the electronic device of any one of examples 1-14, wherein the key corresponds to one of a function key or an on/off key.
Example 16 includes an electronic device comprising a keyboard including an array of keycaps, a first keycap of the array of keycaps including a cavity to enclose a switch assembly, the first keycap including an opening adjacent to the switch assembly to place the cavity in fluid communication with an external environment, and a speaker positioned proximate the first keycap to produce sound that enters the cavity and passes through the opening.
Example 17 includes the electronic device of example 16, further including a baseplate between the speaker and the first keycap, the baseplate including a duct to provide an air path between the speaker and the cavity of the first keycap.
Example 18 includes the electronic device of example 17, wherein the speaker, the duct, and the cavity are arranged in a straight line.
Example 19 includes an electronic device comprising a baseplate, a keycap supported by the baseplate, and a speaker, the baseplate between the key and the speaker, the baseplate including a first opening aligned with the speaker and the keycap, the keycap including a second opening, the first and second openings to define a travel path for soundwaves from the speaker through the baseplate and through the keycap.
Example 20 includes the electronic device of example 19, further including a switch assembly at least partially within a cavity of the keycap, the switch assembly including an arm that is positioned to direct the soundwaves from the first opening towards the second opening.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An electronic device comprising:
a housing;
a keyboard carried by the housing, the keyboard including a key having a keycap that covers an associated switch; and
a speaker within the housing underneath the keyboard, the keycap including an opening to define a port through which sound from the speaker is able to pass.

2. The electronic device of claim 1, wherein the keycap includes a front face and a sidewall, the opening in the sidewall.

3. The electronic device of claim 2, wherein the sidewall is a user-facing sidewall.

4. The electronic device of claim 2, wherein the sidewall is a first sidewall that extends between second and third sidewalls of the keycap, the opening closer to the second sidewall than the opening is to the third sidewall.

5. The electronic device of claim 2, wherein the sidewall is a first sidewall and the opening is a first opening, the keycap including a second opening in a second sidewall.

6. The electronic device of claim 5, wherein the first opening has a first width and the second opening has a second width, the first width greater than the second width.

7. The electronic device of claim 6, wherein the switch is a scissor switch that includes a first arm angled relative to a second arm in a scissor shape, the first and second arms having respective first ends proximate the second sidewall and respective second ends distal to the second sidewall.

8. The electronic device of claim 7, wherein the first end of the first arm is closer to the front face than the first end of the second arm is to the front face, the first arm is closer to the first sidewall than the second arm is to the first sidewall, and the first opening is closer to the first end of the first arm than to the second end of the first arm.

9. The electronic device of claim 5, wherein the first and second sidewalls are joined at a first edge, both the first and second openings adjacent the first edge and distal to opposing edges of the first and second sidewalls.

10. The electronic device of claim 2, wherein the keyboard includes a baseplate, the baseplate between the speaker and the keycap, the baseplate including a duct therethrough, the duct aligned with the keycap to provide a fluid path for air from the speaker to the opening.

11. The electronic device of claim 2, wherein the opening is a cutout that extends from a rear rim of the keycap toward the front face.

12. The electronic device of claim 1, further including a mesh across the opening.

13. The electronic device of claim 1, further including a backlight assembly to illuminate the keyboard, the backlight assembly between the keyboard and the speaker, the backlight assembly including a through-hole to define an air passage between the speaker and the opening in the keycap.

14. The electronic device of claim 1, wherein the key is a first key, and the keycap is a first keycap, the speaker to span an area at least partially aligned with the first key and at least partially aligned with a second key of the keyboard, the second key adjacent to the first key, the second key including a second keycap, the second keycap including a second opening.

15. The electronic device of claim 1, wherein the key corresponds to one of a function key or an on/off key.

16. An electronic device comprising:
a keyboard including an array of keycaps, a first keycap of the array of keycaps including a cavity to enclose a switch assembly, the first keycap including an opening adjacent to the switch assembly to place the cavity in fluid communication with an external environment; and
a speaker positioned proximate the first keycap to produce sound that enters the cavity and passes through the opening.

17. The electronic device of claim 16, further including a baseplate between the speaker and the first keycap, the baseplate including a duct to provide an air path between the speaker and the cavity of the first keycap.

18. The electronic device of claim 17, wherein the speaker, the duct, and the cavity are arranged in a straight line.

19. An electronic device comprising:
a baseplate;
a keycap supported by the baseplate; and
a speaker, the baseplate between the key and the speaker, the baseplate including a first opening aligned with the speaker and the keycap, the keycap including a second opening, the first and second openings to define a travel path for soundwaves from the speaker through the baseplate and through the keycap.

20. The electronic device of claim 19, further including a switch assembly at least partially within a cavity of the keycap, the switch assembly including an arm that is positioned to direct the soundwaves from the first opening towards the second opening.
